(19) United States
(12) Patent Application Publication
(10) Pub. No.: US 2002/0107624 A1
(43) Pub. Date: Aug. 8, 2002

(54) Monitoring equipment for an agricultural machine

(75) Inventor: Arnold Rutz, Zweibrucken (DE)

Correspondence Address: Kevin J. Moriarty, Patent Department, DEERE & COMPANY, One John Deere Place, Moline, IL, 61265-8098, US

(73) Assignee: Deere & Company, a Delaware corporation

(21) Appl. No.: 09/780,105

(22) Filed: Feb. 7, 2001

(51) Int. Cl. G06G 7/76

(52) U.S. Cl. 701/50; 701/29

(57) ABSTRACT

The entire right, title and interest in and to this application and all subject matter disclosed and/or claimed therein, including any and all divisions, continuations, reissues, etc., thereof are, effective as of the date of execution of this application, assigned, transferred, sold and set over by the applicant(s) named herein to Deere & Company, a Delaware corporation having offices at Moline, Ill. 61265, U.S.A., together with all rights to file, and to claim priorities in connection with, corresponding patent applications in any and all foreign countries in the name of Deere & Company or otherwise.

### BACKGROUND OF THE INVENTION

1. Field of the Invention

The present invention is directed to monitoring equipment for an agricultural machine, comprising a process computer located on the agricultural machine, a sensor sensing operational characteristics of the agricultural machine and submitting data containing an information about the sensed characteristics to the process computer, and a communication interface connected to the process computer which is arranged to send fault messages to a station remote from the agricultural machine.

2. Description of the Prior Art

In the German journal BMT Baumaschine+Bautechnik 11-42 (1996), page 46 so-called tele service systems are described, allowing a remote diagnosis, service and control of machines. Thus, data concerning operational characteristics of a machine are sent wirelessly to a central service point, and data for adjusting or controlling the machine are sent back to the machine. Among others, these systems can be used on agricultural machines.

British patent application GB 2 623 376 A describes a vehicle monitoring equipment comprising an assessment means, such as a computerized engine management system, for providing data concerning a predefined operational parameter of the vehicle. Data transmission means are connected to the data assessment means for transmitting such data over a radio link to data reception means remote from the vehicle, for example at a maintenance center. In case the monitoring equipment detects the development of a dangerous fault, it can cause its associated data transmission means to dial the number of the master diagnostics computer to notify personnel at the monitoring station of the fault. The master diagnostics computer sends regular requests to the vehicle, and the monitoring equipment of the latter gives a status report to the monitoring station.

In case of a serious fault, the vehicle monitoring equipment of GB 2 263 376 A thus sends a fault message to the monitoring station. It is not disclosed how the monitoring equipment evaluates the fault, and what data is transmitted.

### SUMMARY

It is an object of the present invention to provide improved monitoring equipment for an agricultural machine which is capable of sending fault messages to a remote station. The monitoring equipment permits fast identification of the error at the remote station. Further, notice should not only be given when faults of operative parts occur, but also when the performance of the agricultural machine is inefficient and/or falling outside predetermined thresholds.

The present invention is provided with monitoring equipment comprising a process computer that is connected to at least one sensor measuring an operational characteristic of the agricultural machine. The process computer evaluates the data received from the sensor and checks whether the data indicates a fault in the agricultural machine. In this case, the data may be below and/or above predetermined thresholds. When such a fault or error occurs, the process computer submits a fault message to a remote station using a communications interface. The fault message contains information identifying the type of the fault.

At the remote location, an identification of the error can thus be fast and easily determined. It is not necessary to process the data from the sensor at the remote location, avoiding a costly and time-consuming transmission of data from the sensor or sensors to the remote location for allowing an identification of the type of the error at the remote station. The monitoring equipment can be arranged to check operational characteristics of operative parts of the agricultural machine, for example parameters of the main engine, oil pressure, temperature and number of rotations. It can also watch operational parameters of any other part of the machine, as number of rotations of a crop processing means, the conveying speed of crop conveying means or, in case of a tractor or telescopic loader, a load of a lifting or towing means of the agricultural machine.

In a preferred embodiment, a sensor of the monitoring equipment is capable of measuring a crop processing characteristic of the agricultural machine. An example is the amount of lost grain in a threshing and separating process, or the amount of processed crop. When the crop processing characteristics are outside predetermined thresholds, i.e. machine performance is poor, the monitoring equipment is arranged to submit a fault message to the remote station. Thus, it is possible to take measures to rectify the fault during harvesting. For example, it is possible to send a car with spare parts to the field on which the agricultural machine is working, if required.

In another embodiment, the monitoring equipment submits a service interval fault to the remote location in the case that a predefined service interval is exceeded.

### BRIEF DESCRIPTION OF THE DRAWINGS

FIG. 1 shows a schematic view of an agricultural combine and a remote service station.

FIG. 2 is a flow diagram illustrating a software routine run in the process computer of the combine checking for dangerous faults.

FIG. 3 is a diagram schematically showing a fault message identifying a dangerous fault.

FIG. 4 is a flow diagram illustrating a software routine checking for incoming messages identifying a dangerous fault.

### DETAILED DESCRIPTION

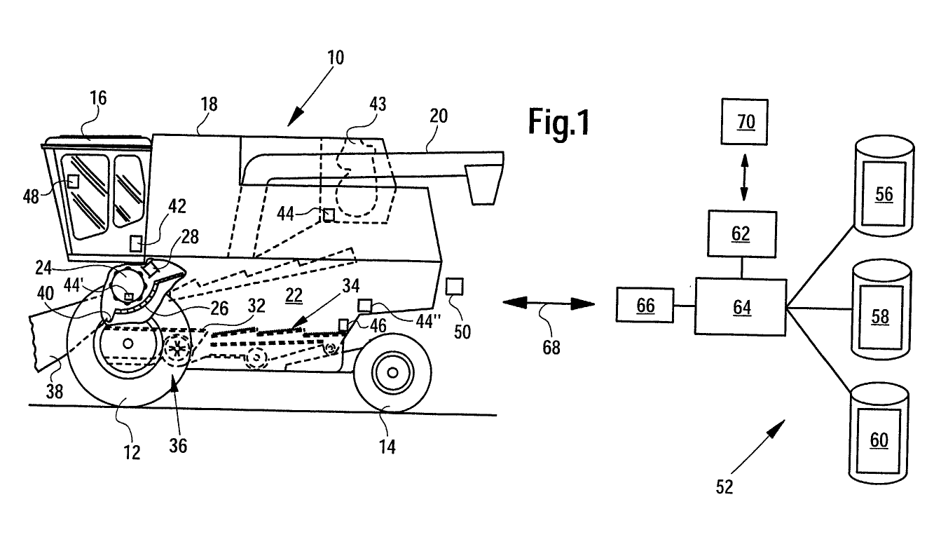

FIG. 1 illustrates an agricultural vehicle in the form of a self-propelled agricultural combine 10. The combine 10 is supported on front and rear wheels 12 and 14. The combine 10 is provided with an operator's cab 16 from which an operator controls the combine. A grain tank 18 is located behind the operators cab 16. Grain located in the grain tank 18 can be directed to a grain cart or other transport mechanism by a discharge auger 20. The grain tank 18 is supported on a frame 22. The frame 22 encloses a threshing cylinder 24, a threshing concave 26 and a beater 28 for threshing harvested crop material. Straw walkers 30 are located downstream from the beater 28 for receiving the threshed crop material. A grain pan 32 is located below the threshing concave 26 and straw walkers 30 for receiving grain and fines. The grain pan 32 directs the grain and fines to sieves 34. The crop residue, i.e. straw, is conveyed over the straw walkers 30 into a rear hood of the combine 10 where it falls onto the ground and lighter components are blown by a blower 36 from the sieves 34 onto the ground. The cleaned grain is directed to the grain tank by an elevator, not shown. The crop is harvested from the field by a header, not shown, at the front of the combine 10 and is conveyed into the combine by a feederhouse 38, past a stone trap 40 and to the threshing cylinder 24. The embodiment illustrated in FIG. 1, is of a conventional combine having a transverse threshing cylinder and axially arranged straw walkers. However the present invention could also be used with other combine configurations including combines having a transverse threshing cylinder and one or more axially aligned rotors in place of the straw walkers, or combines having one or more axially aligned rotors in place of the transverse threshing cylinder and straw walkers.

The combine 10 is provided with a process computer 42 connected to sensors 44, 44′ and 44″ detecting the status of at least one operative part of the combine 10. In the illustrated embodiment, a first sensor 44 is located at the main engine 43 of the combine 10 and detects its operating characteristics, for example, the number of rotations and the oil pressure. A second sensor 44′ is located at the left side of the threshing cylinder 24 and measures the number of rotations the threshing cylinder 24 performs. A third sensor 44″ is located below the rear end of the straw shakers 30 and detects the amount of lost grain. Normally, a relatively high number of sensors 44 for detecting assigned operative parameters are provided on the combine 10. These sensors 44, 44′ and 44″ are connected to the process computer 42 by a bus system, like a CAN-bus. The bus system allows for the quasi-simultaneous communication between the process computer 42 and the sensors 44, 44′ and 44″.

The process computer 42 is further connected to a control system comprising at least one actuator 46 for moving operative elements of the combine 10. In the described embodiment, the actuator 46 is arranged to adjust the position of the louvers or the sieves 34. Such an actuator 46 is described in European patent application EP 1068793 A. In another embodiment of the invention, the control system can control the concave clearance or the propelling speed of the combine 10.

The process computer 42 is connected to a driver's information system comprising a display 48 in the operator's cab 16. On the display 48, information regarding the status of the operative parts of the combine 10 is given to the operator. The driver's information system 48 further comprises input means such that the driver can influence the operation of the combine 10. He can thus input, for example, the number of rotations of the threshing cylinder 24 or override proposals given by the process computer 42, which are displayed on the display 48.

The process computer 42 is additionally connected to a communication interface 50 allowing communication with external stations. This communication channel can make use of any wireless communication means, as a public telephone network. The communication interface 50 of the combine 10 is thus arranged to communicate wirelessly via a communication medium schematically indicated at 68 with a communication interface 66 of a service station 52 at a remote location.

The service station 52 comprises a service computer 64 connected to the communication interface 64. The service computer 64 does not have to be directly connected to the communication interface 66. It can alternatively be part of a network and can communicate via the internet (or another network) with the communication interface 66.

The service computer 64 is also connected to three memories 56, 58 and 60. The first memory 56 contains a database containing product data. The product data comprise information on nominal operative characteristics of the combine 10. The second memory 58 contains a database containing machine data regarding the respective combine, such as manufacturing date. The third memory 60 contains a database containing maintenance data on the maintenance services already performed on the combine 10.

The service computer 64 is also provided with an interface 62 to external services. The interface 62 can thus be used for communicating with a communication assembly 70 of a owner, allowing the latter to countercheck whether his combine 10 was serviced in the intervals recommended by the manufacturer. The interface 62 can also set up a connection to a computer of the manufacturer, for updating the first memory 56. The communication assembly 70 could alternatively communicate with the communication interface 66, thus avoiding the interface 62. In addition, the service computer 64 could be linked via a network (Internet, LAN, etc) to a computer of the machine owner, of a dealer, of a repair shop, or of a manufacturer.

The communication assembly 70 can be a portable or stationary computer connected to a transmission and receiving device. The communication assembly 70 is also capable of displaying operational parameters of the combine 10 to the owner. The owner could also be able to influence operational parameters of the combine 10.

The service station 52 can be located at the office of a service center for agricultural machines, e.g. at a dealer's house, or at a subsidiary of the manufacturer of the combine. It can also be located in the office of a contractor or of a farmer.

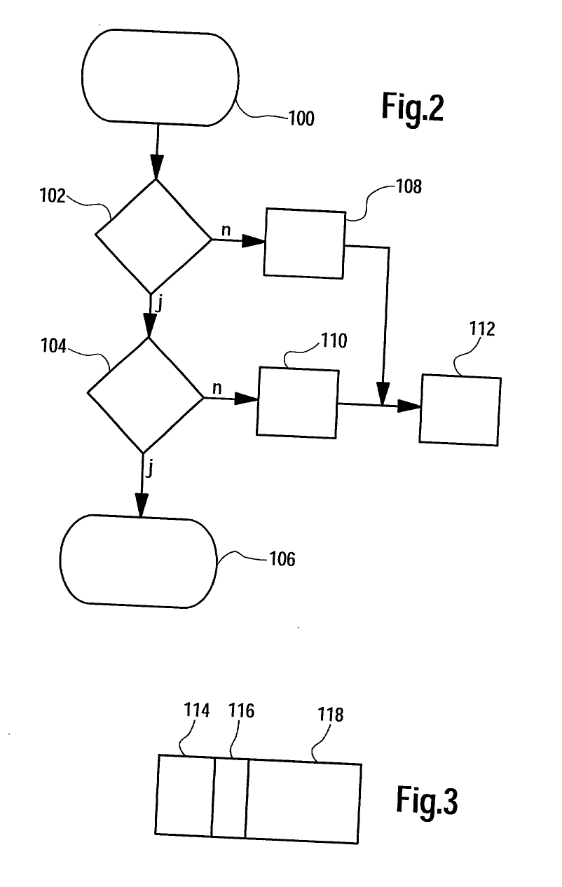

In FIG. 2, a software routine run in the process computer 42 of the combine 10 is illustrated. The routine is normally not run continuously, but in predefined intervals, e.g. at 100 millisecond intervals. The routine starts in step 100 and in subsequent step 102 it checks whether the values measured by the sensors 44, 44′ provided on the combine are within predefined ranges. These predefined ranges are the normal operational ranges, generally comprising a certain margin of error. When for example the oil pressure in the main engine 43 of the combine 10 watched by sensor 44 is beyond the predetermined range, the result of step 102 is “no”. In this case, step 108 follows in which the process computer 42 computes a fault information from the information delivered by sensor 44. This fault information can correspond for example to the fact that the oil pressure is too high. It would also be possible to identify an operative element of the combine 10 causing the fault, when an appropriate sensor 44 is provided.

When step 102 reveals no fault, step 104 is executed in which the process computer 42 checks whether performance parameters are outside a predetermined range. The performance parameters can be extracted from data provided by sensors 44, 44′ and 44″. They can be used to compute, for example, the amount of fuel burnt for harvesting a predefined area. Sensor 44″ allows a measurement of the percentage of grain lost in the threshing and separating process. When the performance parameter is outside the predetermined range, step 110 is executed in which fault information is computed from the data of the sensors 44, 44′ and/or 44″. It can contain an information on the affected parameter, or in a more sophisticated embodiment, which operative part of the combine is not working (or adjusted) properly. When step 104 reveals no fault, the routine ends at step 106. It should be mentioned that it would be possible to send a fault message when a service interval was exceeded in an embodiment in which the information stored in the third memory 60 is provided on board the combine 10.

Both steps 108 and 110 are followed by step 112, in which a fault message containing information about the identified error is sent to the communication interface 66 of the service station 52 by means of the communication interface 50 of the combine 10. Corresponding information is displayed to the driver via the display 48 in the operator's cab 16.

A fault message is schematically indicated in FIG. 3. The message contains three blocks. A first data block 114 is a message identifier, identifying the message as a fault message. A second data block 116 of the message is containing the fault information computed in steps 108 or 110. This fault information contains the type of fault, as engine fault or fault in the crop processing means of the combine, or a performance fault indicating that a performance of the combine 10 is below a predefined limit. A third data block 118 of the message is containing data measured by the sensors 44, 44′ and 44″, or information computed therefrom. The third data block also contains data identifying the combine 10 and its location.

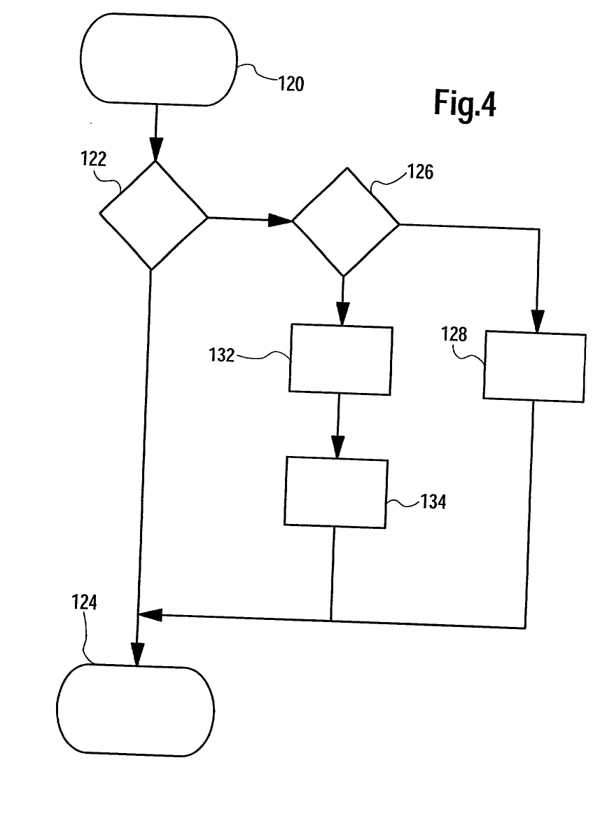

FIG. 4 shows a flow diagram of a routine run in the service computer 64 for checking for incoming fault messages. This routine does not have to run continuously, but it would be sufficient when it is executed in predefined time intervals, at 1 second intervals. The routine starts in step 120, which is followed by step 122, in which a check is performed whether an external message has been received. These messages can be stored in a mailbox. When no message has been received, step 124 follows in which the routine ends.

On the other hand, when a message was received in step 122, step 126 is performed in which an investigation is performed whether the message is a fault message. This check is performed by checking whether the message identifier identifies the message as a fault message. When the result is “no”, step 128 is performed in which the message is processed normally. Thus, for example entries may be made in the first memory 56 when a message containing performance data of the combine 10 have been received, which may be a response to a request initiated by the service computer 64, or requested by the owner via his communication means 70. In case the result of step 126 is “yes”, step 132 is performed in which error data is extracted from the second data block 116 of the message. This data is displayed to an operator of the service computer 64, such that the operator can initiate appropriate steps. The fault message can also be sent to the communication assembly 70 of the owner.

The fault message thus allows the service computer 64 to check rapidly and easily which kind of fault has occurred and to propose appropriate measures to the service personnel. Not only when a fault occurs, but also when a predetermined performance threshold is exceeded, a message is sent from the agricultural implement to the service station 52.

Having described the preferred embodiment, it will become apparent that various modifications can be made without departing from the scope of the invention as set forth in the accompanying claims.

I claim:

1. Monitoring equipment for an agricultural machine, comprising a process computer provided on the agricultural machine, a sensor sensing operational characteristics of the agricultural machine and submitting data containing information about the sensed characteristics to the process computer, and a communication interface connected to the process computer which is arranged to send fault messages to a station remote from the agricultural machine, wherein the process computer is operable to identify a fault from the data provided by the sensor and to submit a fault message to the communication interface, wherein the fault message comprises fault information identifying a type of the fault.

2. Monitoring equipment as defined by claim 1, wherein the type of fault is at least one of an operational part fault and a crop processing fault.

3. Monitoring equipment as defined by claim 2, wherein an operational parts fault corresponds to operational data of the operational parts exceeding a predefined threshold, and a crop processing fault corresponds to crop processing characteristics of the agricultural implement exceeding a predefined threshold.

4. Monitoring equipment as defined by claim 2, wherein the type of fault is a service interval fault indicating that a predefined service interval is exceeded.

5. Monitoring equipment as defined by claim 2, wherein the operational data of the operational parts is data concerning at least one of an engine oil pressure, an engine temperature, number of rotations of an engine, and number of rotations of an operative element of the agricultural machine.

6. Monitoring equipment as defined by claim 2, wherein one of the crop processing characteristics of operational parts is the amount of lost grain in a threshing and separating process of a combine.

7. Monitoring equipment of an agricultural machine, comprising a process computer provided on the agricultural machine, a sensor sensing a crop processing characteristic of the agricultural machine and submitting data containing information about the sensed crop processing characteristic to the process computer, and comprising a communication interface connected to the process computer which is arranged to send fault messages to a station remote from the agricultural machine, wherein the process computer is operable to identify a crop processing fault from the data provided by the sensor and to submit a crop processing fault message to the communication interface, wherein a fault message indicating a performance fault is submitted when a crop processing fault is identified.

8. Monitoring equipment as defined by claim 7, wherein a sensor senses operational characteristics of operational parts of the agricultural machine and submits data containing information about the sensed characteristics to the process computer, and the process computer is operable to identify an operational parts fault and to submit an operational parts fault message to the communication interface.

9. Monitoring equipment as defined by claim 8, wherein the fault message comprises fault information identifying a type of fault.

10. Monitoring equipment as defined by claim 8, wherein the operational data of the operational parts is data concerning at least one of an engine oil pressure, an engine temperature, number of rotations of an engine, and number of rotations of an operative element of the agricultural implement.

11. Monitoring equipment as defined by claim 7, wherein one of the crop processing characteristics of operational parts is the amount of lost grain in a threshing and separating process of a combine.
Monitoring equipment of an agricultural machine comprises a process computer provided on the agricultural machine, a sensor sensing operational characteristics of the agricultural machine and submitting data containing information about the sensed characteristics to the process computer, and a communication interface connected to the process computer which is arranged to send fault messages to a station remote from the agricultural machine. The process computer is operable to identify a fault when the data provided by the sensor exceeds a predetermined threshold and to submit a fault message to the communication interface. The fault message comprises fault information identifying a type of fault.
